(19) United States
(12) Patent Application Publication
(10) Pub. No.: US 2009/0216622 A1
(43) Pub. Date: Aug. 27, 2009

(54) MUSIC-LINKED ADVERTISEMENT DISTORIBUTION METHOD, DEVICE, AND SYSTEM

(76) Inventors: Keiichiro HOASHI, Saitama (JP); Hiromi ISHIZAKI, Saitama (JP); Fumiaki SUGAYA, Saitama (JP)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/390,673

(22) Filed: Feb. 23, 2009

(30) Foreign Application Priority Data
Feb. 26, 2008 (JP) 2008-044332

(51) Int. Cl. G06Q 30/00; G06N 5/02; G06Q 10/00; G06F 17/30

(52) U.S. Cl. 705/10; 706/13; 705/14; 707/104.1; 705/27; 707/E17.102; 707/E17.046

(57) ABSTRACT

Degrees of association between categories of songs (hereinafter, song categories) corresponding to information showing advertisement distribution target categories and distribution object advertisements are determined in advance in an advertisement DB. A song categorization module calculates degrees of association between an acoustic feature amount of a song being played (hereinafter, current song) and feature amounts of the song categories, and a song-related distribution object advertisement candidate group extraction module determines a distribution object advertisement corresponding to a song category with a high degree of association is determined as a distribution object advertisement. An advertisement presentation module provides information on the distribution object advertisement to a user along with current song information.

The present application is claims priority of Japanese Patent Application Serial No. 2008-044332, filed Feb. 26, 2008, the content of which is hereby incorporated by reference in its entirety.

### BACKGROUND OF THE INVENTION

1. Field of the Invention

The present invention relates to a music-linked advertisement distribution method, device, and system, and specifically, to a music-linked advertisement distribution method, device, and system which can attach contents with advertisements suitable for the contents and distribute these to users.

2. Description of the Related Art

As a method for distributing and providing contents to users at no charge or a low price, a business model in which advertisement fees are collected from advertisers to cover costs necessary for contents distribution has become popular. Typical services adopting such an advertisement model are television and radio broadcasting. For example, in the case of television broadcasting (commercial television), advertisements are broadcasted between video contents being broadcasted, and advertisement fees of these enable broadcasting of television programs at no charge to users. Further, advertisers can promote their commercial goods to many users, so that this is a beneficial business model.

Along with the recent popularization of audio encoding systems such as MP3, music contents distribution services have increasingly spread, and as in the case of the above-described television and radio broadcasting, there is an example in which contents are distributed while advertisements are attached thereto. For example, in a network music broadcasting service called “Brandnew J” provided by J-Wave Ins., music programs are stream-broadcasted on the Internet, and between songs, voice advertisements from advertisers are inserted. Also in video Internet broadcasting, like “Gyao” provided by USEN, there is an example in which video contents are attached with advertisements and broadcasted on the Internet (refer to Patent Documents 1 and 2).

In the case of distribution of the above-described broadcasting contents, advertisements with the same contents are distributed to all users who are listening to or viewing the contents, so that advertisement information suitable to the interests of each user cannot be distributed. As one of the prior examples for solving this drawback, there is a method in which contents to be purchased by users are attached with advertisement data individually. For example, in Patent Document 3, in a music distribution service, a system for generating contents in which advertisement voices are embedded in songs to be provided has been proposed. Further, in Patent Document 4, in a music distribution service, a system in which information on advertisements corresponding to a song that a user designated is attached to the song as well as advertisement playback time information and provided to the user, has been proposed. Further, in Patent Document 5, when audio contents like a podcast are attached with advertisements, to make it possible to satisfy both an advertiser and a contents provider, a system in which contents attached with advertisements are created after the contents provider approves these, has been proposed.

In the above-described prior art, contents and advertisements to be attached to the contents are fixed in advance, and on the other hand, there has also been proposed a method in which advertisement-related information to be attached to the contents can be dynamically changed. For example, in Patent Document 6, a system in which on condition that advertisements are distributed by a wireless unit, according to a distance to a distribution device, advertisements to be attached when contents are played back is determined, has been proposed. In Patent Document 7, a system in which a user receives an HTML-format document including hyperlink information on a song played back by a user has been proposed. This system makes it possible for a third party to create information to be attached to the song.

On the other hand, as an advertisement providing method on the web, search-linked advertisements and contents-linked advertisements are typical, and Google, etc., provide such services. Search-linked advertisements are a method in which advertisements related to a search keyword input by a user is presented within a search engine, such as Google, etc. Contents-linked advertisements are a method in which advertisements related to a keyword appearing on a Web page which a user browses is presented.
Patent Document 1: Japanese Published Unexamined Patent Application No. 2007-96723 “Advertisement-attached contents distribution system”
Patent Document 2: Japanese Published Unexamined Patent Application No. 2004-140584 “Contents distribution and playback system, advertisement contents insertion method and client terminal”
Patent Document 3: Japanese Published Unexamined Patent Application No. 2002-116767 “Music data distribution device”
Patent Document 4: Japanese Published Unexamined Patent Application No. 2002-73050 “Music distribution server, music playback terminal, and storage medium storing distribution server processing program and storage medium storing terminal processing program”
Patent Document 5: Japanese Published Unexamined Patent Application No. 2002-0334266 “Advertising device, advertising system, advertising method, advertising program and medium for the same”
Patent Document 6: Japanese Published Unexamined Patent Application No. 2004-54693 “Information processing device and method, information processing system, storage medium, and program”
Patent Document 7: Japanese Published Unexamined Patent Application No. 2007-164078 “Song playing device and song information distribution server”

Among the above-described prior examples, regarding advertisement attachment to broadcasting contents as shown in Patent Document 1 and 2, the same advertisements are distributed to all viewers and listeners as described above, so that there is a problem that advertisements suitable to the interests of each user are not always distributed. Contents of the advertisements to be attached to the broadcasting contents greatly reflect the intentions of the advertisers (sponsors), so that advertisements not suitable for the contents to be broadcasted may be attached, and thereby, there is a possibility that it does not attract the users' interests.

In the method in which advertisements are attached to individual contents as proposed in Patent Documents 3 to 5, suitability between contents and advertisements is solved to some degree among the above-described problems. However, in these prior examples, when advertisement-attached contents are generated, the contents are fixed, so that it is difficult to attach new advertisements to contents which a user purchased in the past.

On the other hand, according to the method proposed in Patent Documents 6 and 7, new advertisements can be attached to contents which are being played back by a user. However, in the system of Patent Document 6, advertisements are attached to the contents being played back irrelevantly, so that suitability between the advertisements and contents is not guaranteed. In the system of Patent Document 7, information on contents to which advertisements are attached must be stored in an advertisement distribution server. Therefore, advertisements cannot be attached to contents which, for example, individual users prepared and created by themselves (for example, a music file ripped from a CD).

In the case of search-linked advertisements and contents-linked advertisements provided by Google, Inc., etc., target contents to which advertisements are attached are limited to text information. Therefore, to multimedia contents such as music and video, advertisements suitable for the contents cannot be attached when the contents have no meta information describing the contents.

### SUMMARY OF THE INVENTION

An object of the present invention is to provide a music-linked advertisement distribution method, device, and system by which, when a user plays back music with a music playing device, advertisements corresponding to a feature of the music being played back are automatically selected and provided to the user.

In order to achieve the object, the present invention is firstly characterized in that a music-linked advertisement distribution method comprises determining degrees of association between categories of songs (hereinafter, song categories) corresponding to information showing advertisement distribution target categories and distribution object advertisements in advance, calculating the degrees of association between an acoustic feature amount of a song being played back (hereinafter, a current song) and feature amounts of the song categories, determining a distribution object advertisement corresponding to a song category with high degree of association as a distribution object advertisement, and providing information on the distribution object advertisement to a user along with current song information.

The present invention is secondly characterized in that a music-linked advertisement distribution device comprises a means for extracting features of songs stored in a song DB, a means for playing back a song stored in the song DB, a means for extracting features of categories of songs (hereinafter, song categories) corresponding to information showing advertisement distribution target categories, a means for obtaining an advertisement distribution target category of a song being played back (hereinafter, current song) based on the degrees of association between an acoustic feature of the current song and features of the song categories, a means for determining a distribution object advertisement based on the advertisement distribution target category, a means for extracting information on the distribution object advertisement from an advertisement DB, and a means for providing information on the distribution object advertisement to a user along with current song information.

The present invention is thirdly characterized in that a music-linked advertisement distribution system comprises a means for extracting features of songs stored in a song DB, a means for playing back a song stored in the song DB, and a means for providing information on a distribution object advertisement to a user along with information on a song being played back (hereinafter, current song), provided in a client terminal, and a means for extracting features of categories of songs (hereinafter, song categories) corresponding to information showing advertisement distribution target categories, a means for obtaining an advertisement distribution target category of a current song based on the degrees of association between an acoustic feature of the current song and features of the song categories, a means for determining a distribution object advertisement based on the advertisement distribution target category, and a means for extracting information on the distribution object advertisement from an advertisement DB, provided in an advertisement distribution server, wherein the client terminal and the advertisement distribution server are connected through a network.

The present invention is fourthly characterized in that a music-linked advertisement distribution system comprises a means for extracting features of songs stored in a song DB, provided in a music distribution server, a means for downloading a song designated by a user in the song DB and a feature of the song, a means for storing the downloaded song and feature of the song, a means for playing back the downloaded song, and a means for providing information on a distribution object advertisement to the user along with information on a song being played back (hereinafter, current song), provided in a client terminal, a means for extracting features of categories of songs (hereinafter, song categories) corresponding to information showing advertisement distribution target categories, a means for obtaining an advertisement distribution target category of the current song based on the degrees of association between an acoustic feature of the current song and features of the song categories, a means for determining a distribution object advertisement based on the advertisement distribution target category, and a means for extracting information on the distribution object advertisement from an advertisement DB, provided in an advertisement distribution server, wherein the music distribution server, the client terminal, and the advertisement distribution server are connected through a network.

The present invention is fifthly characterized in that a music-linked advertisement distribution system comprises a means for extracting features of songs stored in a song DB, provided in a PC, a means for storing a song and a feature of the song transferred from the PC, a means for playing back the transferred song, and a means for providing information on distribution object advertisement to a user along with information on a song being played back (hereinafter, current song), provided in a portable music playing device, a means for extracting features of categories of songs (hereinafter, song categories) corresponding to information showing advertisement distribution target categories, a means for obtaining an advertisement distribution target category of a current song based on the degrees of association between an acoustic feature of the current song and features of the song categories, a means for determining a distribution object advertisement based on the advertisement distribution target category, and a means for extracting information on the distribution target advertisement from an advertisement DB, provided in an advertisement distribution server, wherein the portable music playing device and the advertisement distribution server are connected through a network.

According to the music-linked advertisement distribution method and device of the present invention, different from conventional broadcasting advertisement distribution (a method for distributing the same advertisements to all users), it becomes possible to present advertisements suitable for music being played back by each user, and improvement in advertisement effectiveness for users can be expected.

According to the music-linked advertisement distribution system of the present invention, in addition to the above-described effect, advertisements can be distributed to users of client terminals connected to a network, and regardless of the locations of the users, advertisements can be distributed.

Among prior examples introduced in the description of conventional techniques, in comparison with the methods proposed in Patent Documents 3 to 5 in which advertisements to be distributed together with contents (including music) are fixed, in the present invention, a plurality of distribution object advertisement groups are dynamically associated with a song to be played back, so that new advertisements suitable for the song to be played back can be displayed as required, and an continuous advertisement effectiveness can be expected.

Among prior examples in which advertisements can be dynamically attached, the relationship between a song being played back and advertisements to be distributed is not considered in Patent Document 6, and on the other hand, according to the present invention, advertisements having a correlation with a feature of the song are presented, so that a higher advertisement effectiveness is expected. In the same Patent Document, an advertisement distribution location is limited to be near a wireless unit, however, according to the present invention, regardless of the location of a user, advertisements can be distributed.

Further, in Patent Document 7, information (for example, including advertisements) can be dynamically attached to a song, however, data which defines the association between the distribution object advertisements and contents (song) is necessary, so that songs to which advisements can be attached are limited. On the other hand, according to the present invention, distribution advertisements are determined based on an acoustic feature extracted from a current song, so that arbitrary songs including, for example, songs created by a user can be attached with advertisements, and advertisement effectiveness can be further increased.

Different from the conventional search-linked advertisements and contents-linked advertisements, in the present invention, text information to which advertisements are linked is not required. Therefore, for various songs, effective advertisements can be presented.

### BRIEF DESCRIPTION OF THE DRAWINGS

FIG. 1 is a block diagram showing a configuration of an embodiment of an advertisement-linked music playing device of the present invention;

FIG. 2 is a view showing an example of a screen image of the present invention;

FIG. 3 is a view showing an example of advertisement information registered in an advertisement DB;

FIG. 4 is a view showing another example of advertisement information registered in the advertisement DB;

FIG. 5 is a flowchart showing an embodiment of an advertisement-linked music playing method of the present invention;

FIG. 6 is a flowchart showing an example of an advertisement provision process when a song is played back;

FIG. 7 is a flowchart showing another embodiment of an advertisement-linked music playing method of the present invention;

FIG. 8 is a flowchart showing another example of an advertisement provision process when a song is played back;

FIG. 9 is a block diagram showing a configuration of an embodiment of an advertisement-linked music playing system of the present invention; and

FIG. 10 is a block diagram showing a configuration of another embodiment of an advertisement-linked music playing system of the present invention.

### DETAILED DESCRIPTION OF THE PREFERRED EMBODIMENTS

Hereinafter, the present invention will be described with reference to the drawings. First, a device configuration of the present invention will be described in detail with reference to FIG. 1. FIG. 1 is a basic configuration view of a moving image contents retrieval device implementing a moving image contents similarity calculating method of the present invention.

As shown in FIG. 1, the present device includes a song DB 10 storing songs to be played back by a user and related information, an advertisement DB 11 storing advertisement information to be distributed to the user, a category learning DB 12 for learning features of categories (described in detail later) of songs with which advertisements are distributed, a category feature DB 13 storing feature information on distribution target categories, a song feature DB 14, and six modules, that is, a song feature extraction module 1, a category feature extraction module 2, a song playing module 3, a song categorization module 4, a song-related distribution object advertisement candidate group extraction module 5, and an advertisement presentation module 6. Processes of the modules are as follows.

In the song feature extraction module 1, a process for extracting features (acoustic features) for calculating correlations on distribution object advertisements from songs stored in the song DB 10 is performed. A feature extraction process will be described in detail later.

In the category feature extraction module 2, a process for learning features of categories to be associated with advertisements to be distributed to users based on information stored in the category learning DB 12 is performed. Here, “category” shows a feature of a song to which distribution object advertisements are linked. In detail, genre information on a song and information showing the mood of a song such as “cheerful” and “healing” are examples of categories in the present invention. Hereinafter, the “category” may be referred to as information showing a category (category information). An advertiser sends a distribution object advertisement to the advertisement DB 11 on the condition that the advertiser additionally provides category information on a song with which the advertiser desires to present the advertisement. Details of the process of this module 2 will be described later.

In the song playing module 3, a process for playing back a song designated by a user with a music playing device (or a portable music playing device) 7, and transmitting information on the song being played to the song categorization module 4, is performed.

In the song categorization module 4, based on information on the song being played obtained from the song playing module 3, feature information on the song being played is obtained from the song feature DB 14. Then, a process for categorizing the song being played by calculating correlation values between feature information on the song being played and feature information on the categories output from the category feature extraction module 2, is performed. Details of the process will be described later.

In the song-related distribution object advertisement candidate group extraction module 5, a process for determining advertisement candidates to be presented along with songs is performed. Details of the process of this module 5 will be described later.

In the advertisement presentation module 6, a process for providing information on advertisements with a high correlation with the song together with information on the song being played on a screen, etc., of the music playing device 7 of the user is performed.

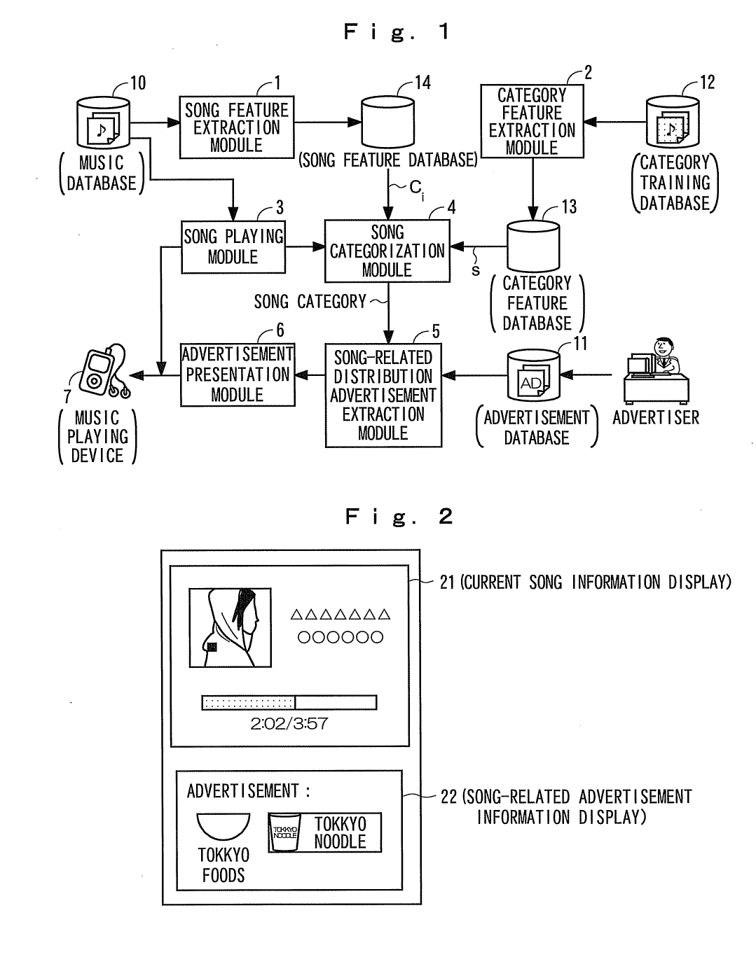

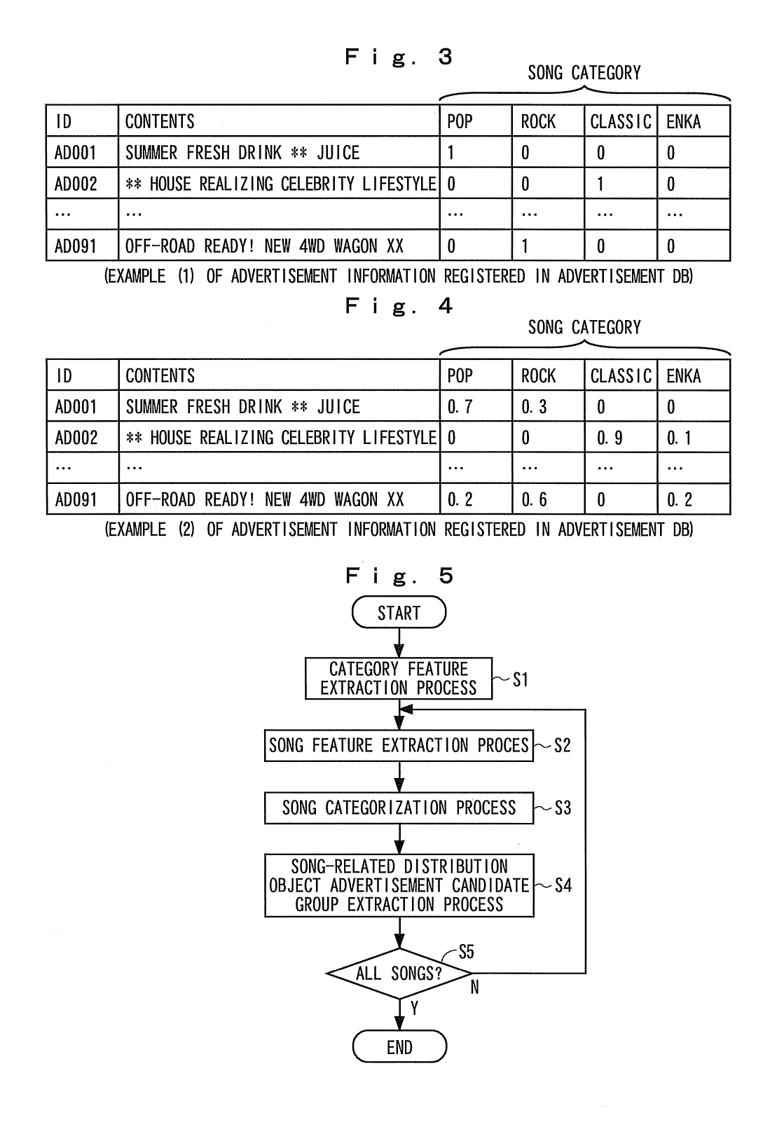

Herein, a screen image of the music playing device 7 equipped with the present invention is shown in FIG. 2.

As shown in FIG. 2, in the present invention, the screen image consists of a current song information display 21 which displays information on a song being played back by a user and a song-related advertisement information display 22 which displays advertisement information related to a song being played back. On the current song information display 21, information on a song being currently played back is displayed. In detail, information such as the title of the song, the performing artist, and the playing status are included. On the song-related advertisement information display 22, advertisement information corresponding to a song being played back is displayed. A method for determining an advertisement related to the song will be described in detail below.

Next, details of processes in the present invention will be described. As described above, in the present invention, correlation values (similarities) of a song being played back by a user and categories set in advance are calculated to obtain the category of the song being played back, and based on this result, a distribution object advertisement to be presented to the user (music playing device) is determined. Processes for realizing the present invention are mainly five as follows.
1. Category feature extraction process (process of category feature extraction module 2)
2. Song feature extraction process (process of song feature extraction module 1)
3. Song categorization process (process of song categorization module 4)
4. Song-related distribution object advertisement candidate group extraction process (process of song-related distribution object advertisement candidate group extraction module 5)
5. Advertisement presentation process (process of advertisement presentation module 6)

In detail, in a rough process flow of the present invention, the processes 1 to 4 are applied to songs to be played back in advance, and then the process 5 is applied when the songs are played back. Hereinafter, the processes will be described in detail.

In the category feature extraction process by the category feature extraction module 2, based on category learning data composed of sample song groups corresponding to category information prepared in advance in the category learning DB 12, a process for extracting features of song categories is performed. In detail, when genre information on the songs are used as category information, the category learning data is composed of song groups corresponding to individual category information (for example, pop, rock, Enka, etc.). Even when category information such as “cheerful,” “healing,” etc., are used, song groups corresponding to the respective category information are prepared. For example, “cheerful” is used as category information, category learning data is composed of song categories (for example, cheerful songs, slightly cheerful songs, normally cheerful songs, and so on) corresponding to individual category information (for example, cheerful, slightly cheerful, normal, and so on).

There are some methods for automatically categorizing music, and here, as an example, a method based on tree vector quantization (TreeQ) proposed in the following reference document [1] will be described.
[1] J. Foote: “Content-based retrieval of music and audio,” Processing of SPIE, Vol. 3229, pp. 138-147, 1997

In Tree Q, features for identifying categories are automatically extracted from song groups to which category information are attached as in the case of the category learning DB of the present invention. In detail, a process for extracting MFCCs (Mel-Frequency Cepstrum Coefficients) from songs and establishing a vector quantization tree expressing features for identifying songs in different categories, is performed. Thereafter, to obtain a vector expressing each category, an MFCC extracted from a song belonging to the category among songs included in the learning data is input into the vector quantization tree to generate a histogram showing the numbers of frames to be overlaid on the respective leaves of the tree. This process is performed for all categories included in the learning data. As a result, when m is the number of categories included in the learning data, m vectors indicating categories C₁, . . . , Cₘ are obtained.

In the song feature extraction process by the song feature extraction module 1, a process for extracting features from all songs to be played back by a user is performed. Feature amounts obtained as a result of this process are used for calculating similarities with category feature amounts obtained as a result of the above-described category feature extraction process, so that the same method as that in the category feature extraction module is applied to the feature extraction process. For example, when the TreeQ method is used, MFCCs extracted from songs are input into the vector quantization tree obtained through the category feature extraction process to obtain song vectors.

In the song categorization process in the song categorization module 4, a process for categorizing songs to be played based on similarities between category vectors s and a song vector C₁ of a song to be played back obtained through the above-described category feature extraction process and song feature extraction process, is performed. In detail, cosine similarities of a song vector Cᵢ and vectors s of categories are calculated according to the following Expression (1).

Sim(s, Cᵢ)=s·Cᵢ|s||Cᵢ| (1)

s·Ci of the right member indicates an inner product of both vectors, and |s| indicates a Euclidean length of the vector s.

As a categorization method, there is a method in which a song is categorized into a category with the maximum similarity. There is another applicable method in which a categorization result is expressed as an m-dimensional vector having elements in which similarities with categories (m in total) are stored.

In the song-related distribution object advertisement candidate group extraction process by the song-related distribution object advertisement candidate group extraction module 5, a process for determining a candidate group of advertisements to be displayed for each song to be played back based on the result of the song categorization process is performed.

Here, an example of registered data in the advertisement DB 11 to be used in this process is shown. Regarding a distribution object advertisement which an advertiser registers in the advertisement DB 11, category information which the advertiser wants to distribute is also registered along with information on the advertisement.

FIG. 3 and FIG. 4 show examples of advertisement information registered in the advertisement DB 11. In FIG. 3 and FIG. 4, examples of song categories corresponding to information showing ID, contents of advertisements, advertisement distribution target categories (category information) are shown. In these figures, for simple description, “Contents” are shown in text, however, contents of the advertisements can be stored in a form such as a banner image.

FIG. 3 shows an example in which song categories corresponding to the respective registered advertisements are limited to only one. In this example, it is assumed that a method is used in which when an advertiser registers an advertisement on the advertisement DB, the advertiser designates one song category with which an advertisement will be distributed.

On the other hand, in the example of FIG. 4, advertisement distribution categories are shown as real numbers between 0 and 1. This case is on the condition that a method is used in which when an advertiser registers an advertisement on the advertisement DB 11, the advertiser designates weighting to each song category as a real number. In FIG. 4, adjustment is made so that the sum of weights of song categories with respect to each advertisement becomes 1 although this is not essential. This adjustment prevents an advertiser from unfairly assigning heavy weights to all song categories.

A distribution advertisement candidate group for a song to be played back is extracted from the advertisement DB 11 by collating the song categories of advertisements registered in the advertisement DB 11 and a song categorization result. For example, in the song categorization process, when a song is categorized into a category with the maximum similarity, the category into which the song is categorized and song categories of advertisements in the advertisement DB 11 are collated with each other. When the data in the advertisement DB 11 are in the form shown in FIG. 3, advertisements matching the song category are extracted as a distribution advertisement candidate group. In the case of the form shown in FIG. 4, a method in which an advertisement having the highest weight to the song category is extracted or a method in which an advertisement having a weight to the category exceeding a threshold is extracted, can be applied. When the song categorization result is calculated in the form of an m-dimensional vector, in the case of the method shown in FIG. 4, the relationships between advertisements and categories can also be expressed as m-dimensional vectors, so that based on cosine similarities expressed as Expression (1) described above, a distribution object advertisement candidate group can be extracted. For example, a method in which an advertisement with higher similarity or advertisement exceeding the threshold is extracted can be adopted.

In the advertisement presentation process by the advertisement presentation module 6, a process for displaying contents of an advertisement included in a distribution object advertisement candidate group extracted for each song being played back by a user on a screen of a music playing device of the user is performed. In detail, information on advertisements included in a distribution object advertisement group corresponding to a song being played back are displayed successively during playing back of the song (see FIG. 2). As a display order of advertisements, random selection from the candidate group or an order of payment amount when advertisements are placed, is applicable. For an advertisement displaying time, a method in which the advertisement display time is displayed at fixed intervals (e.g., each 15 seconds), determined according to a placement price, or designated as an option of the music playing device, is applicable.

In the above-described processes, a process flow from the category feature extraction process to the song-related distribution object advertisement candidate group extraction group will be described in FIG. 5. In FIG. 5, at Step S1, the category feature extraction process is performed, and extracted category features are stored in the category feature DB 13. At Step S2, the song feature extraction process is performed, and extracted song features are stored in the song feature DB 14. Next, at Step S3, a categorization process of a song to be played back is performed by obtaining similarities between the features of the song to be played obtained from the song feature DB 14 and the category features in the category feature DB 13. At Step S4, the song-related distribution object advertisement candidate group extraction process is performed by referring to the advertisement DB 11. At Step S5, it is judged whether the processes of Steps S2 to S4 have been performed for all songs, and when the judgment result is negative, the process returns to Step S2 and repeats the processes of Steps S2 to S4 again. Thereafter, when the judgment result of Step S5 becomes affirmative, the above-described processes are ended.

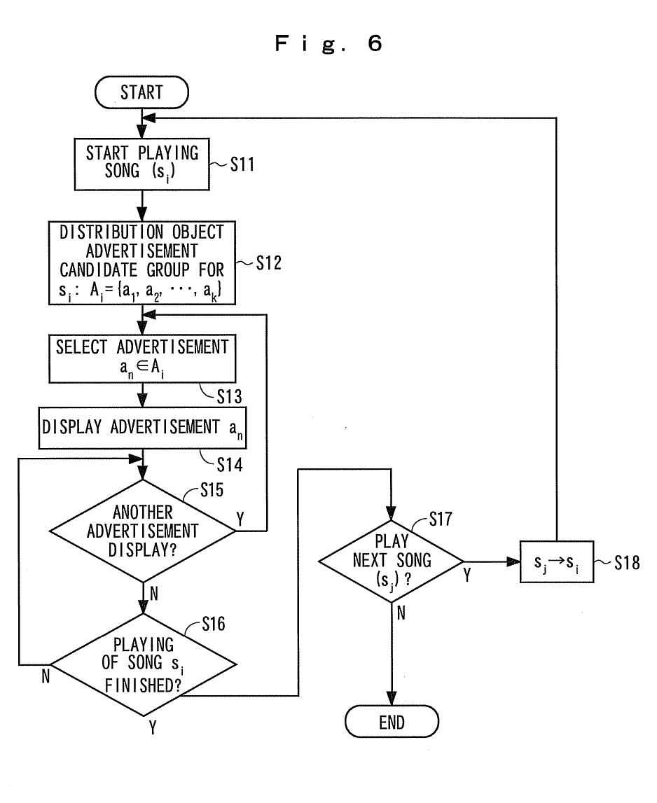

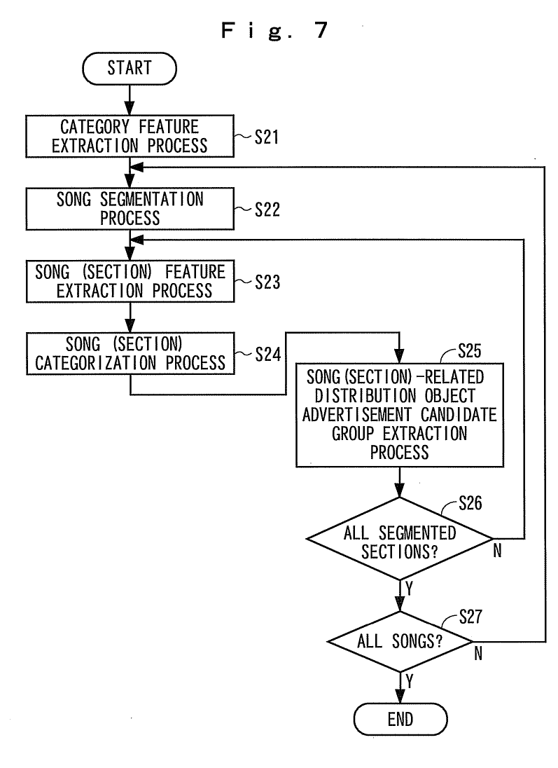

Next, the advertisement presentation process flow when a song is played back is shown in FIG. 6. In FIG. 6, at Step S11, playing of a selected song Sᵢ is started. At Step S12, attention is focused on a distribution object advertisement candidate group Aᵢ for the song Sᵢ. Here, it is assumed that the contents of the distribution object advertisement candidate group Aᵢ are advertisements (a₁, a₂, . . . , aₖ). At Step S13, an advertisement an is selected from the distribution object advertisement candidate group Aᵢ and displayed. To this selection, as described above, random selection or selection in the order of payment amount when placing an advertisement can be applied. Next, the process advances to Step S15, and it is judged whether another advertisement is to be displayed, and then, the process advances to Step S16 and it is judged whether playing of the song Sᵢ has been ended. When the result of this judgment is negative, the process returns to Step S15 and it is judged again whether another advertisement is to be displayed. When another advertisement is to be displayed, the process returns to Step S13 and another advertisement is displayed. When these processes are continued, one or a plurality of advertisements are displayed during one song Sᵢ.

When the judgment result of Step S16 becomes affirmative, the process advances to Step S17 and it is judged whether the next song Sⱼ is to be played back. When this judgment result is affirmative, the song Sⱼ is updated to Sᵢ at Step S18 and the process returns to Step S11, and processes of the Steps S11 to S16 are repeated. Through this process, another one or plurality of advertisements can be displayed during playing back of the song Sⱼ. During the process described above, when the judgment result of Step S17 becomes negative, the advertisement presentation process ends.

Next, a second embodiment of the present invention will be described. In this embodiment, a song to be played back is segmented into a plurality of sections in advance, features are extracted from the respective sections, after that a distribution object advertisement candidate group is extracted for each section. By applying this method, for example, when a great change happens in mood in the same song, advertisement information fitting the feature can be presented.

Regarding the segmentation of a song, when main melody section information is embedded in song data in advance like song data for a cell phone, segmentation can be performed by using such information. The song automatic segmentation process proposed in the following reference document [2] is also applicable.
[2] J. Foote: Automatic audio segmentation using a measure of audio novelty, Proc of ICME 2000, pp. 452-455, 2000.

FIG. 7 shows a process flow until the song(section) -related distribution object advertisement candidate group extraction process in the processes of the present invention to which the song segmentation process is applied. This process flow corresponds to the process flow of FIG. 5.

In FIG. 7, at Step S21, the same category feature extraction process as Step S1 described above is performed. At Step S22, a certain song is segmented. At Step S23, a process for extracting features of sections of the song is performed. At Step S24, the song sections are categorized. Next, at Step S25, section-related distribution object advertisement candidate group extraction process is performed for the song. Subsequently, at Step S26, it is judged whether all segmented sections have been processed, and when the result is negative, the process returns to Step S23 and feature extraction process is performed for the next section. These processes are repeated, and when the judgment result of Step S26 becomes affirmative, the process advances to Step S27, and it is judged whether all songs have been processed. When the result is negative, the process returns to Step S22 and the next song is segmented, and thereafter, the same processes as described above are repeated. As a result, when the judgment result of Step S27 becomes affirmative, the series of processes are ended.

Through the above-described processes, distribution object advertisement candidate groups are extracted from the segmented sections of all songs.

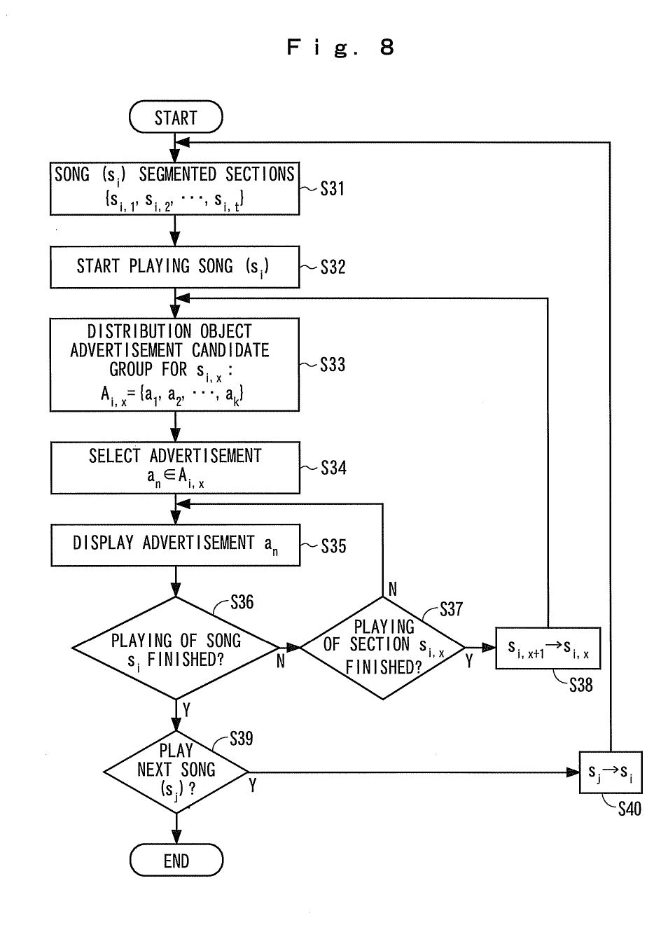

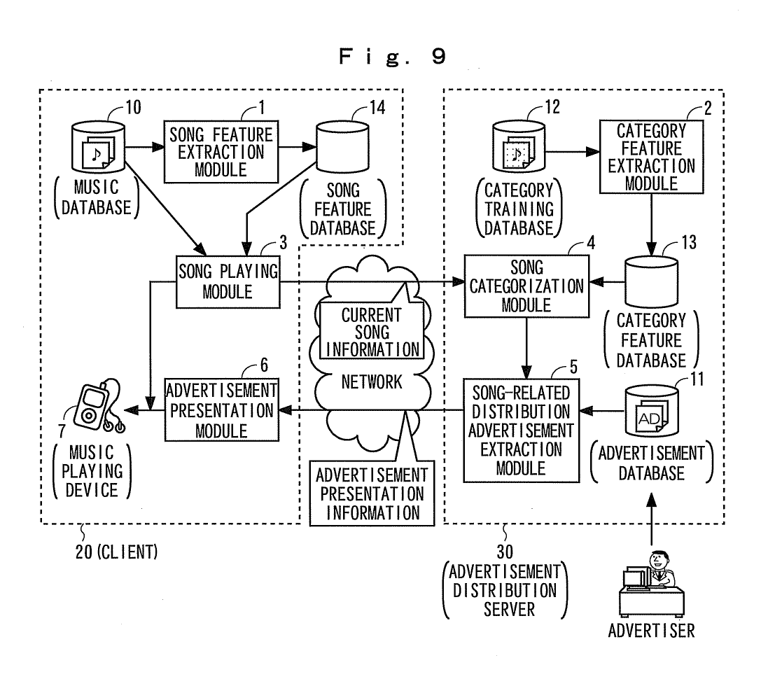

Next, an advertisement presentation process flow when playing back a song in the case where the song segmentation process is applied is shown in FIG. 8. This process flow corresponds to the process flow of FIG. 6.

At Step S31, sections segmented at Step S22 described above from the song Si to be played back are readout. The sections are (S_{i,1}, S_{i,2}, . . . , S_{i,t}). At step S32, the song Sᵢ starts being played back. At Step S33, attention is focused on the distribution object advertisement candidate group A_{i,x} for the section S_{i,x}. Here, A_{i,x}={a₁, a₂, . . . , aₖ}. At Step S34, an advertisement an is selected from the distribution object advertisement candidate group A_{i,x}. To this selection, random selection or selection in the order of payment amount when the advertisement is placed can be applied. At Step S35, this advertisement aₙ is displayed. At Step S36, it is judged whether playing back of the song Sᵢ has been finished. When the result of this judgment is negative, the process advances to Step S37 and it is judged whether playing of the section S_{i,x} has been finished. When the result of this judgment is negative, the process returns to Step S35 and display of the advertisement aₙ is continued. On the other hand, when the result of this judgment is affirmative, the process advances to Step S38 and shifts to the next section S_{i,x+1}. Then, the process returns to Step S33 and attention is focused on a distribution object advertisement candidate group A_{i,x+1} for the section S_{i,x+1}. Hereinafter, the same operations as described above are performed.

When the result of judgment of Step S36 becomes affirmative, the process advances to Step S39, and it is judged whether the next song Sⱼ is to be played back. When the result of this judgment is affirmative, the process advances to Step S40 and the next song Sⱼ is selected, and the process returns to the process of Step S31. Hereafter, the same processes as described above are performed, and when the result of judgment of Step S39 becomes negative, the series of processes are ended.

Through the above-described processes, it is obvious that, during playing of songs, advertisements suitable for the sections of the songs are selected and displayed.

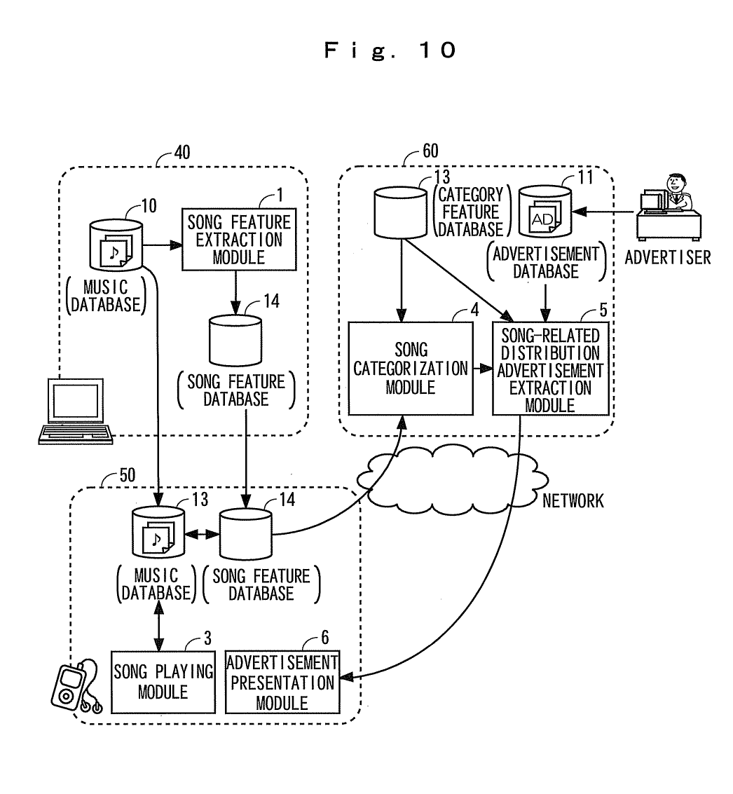

Next, an example of a system implementing the present invention will be described. FIG. 9 is a configuration view in the case where the basic configuration module of FIG. 1 is divided into a client for allowing a user to play back music and browse advertisement information, and a server for distributing advertisement information provided by an advertiser.

In FIG. 9, on the client 20 side, the song feature extraction module 1, the song playing module 3, and the advertisement presentation module 6 are arranged, and on the advertisement distribution server 30 side, the category feature extraction module 2, the song categorization module 4, and the song-related distribution object advertisement candidate group extraction module 5 are arranged. In this configuration, it is assumed that, for example, a user rips a music CD which the user purchased on the PC and accumulates music files to be played back. From the client 20, information on a song being currently played back by the user (including the feature extraction result) is transmitted to the advertisement distribution server 30 via the network, and an advertisement group strongly associated with the song being played back is extracted on the server 30 side. The extracted advertisement information is sent to the client 20 via the network, and on the client 20 side, advertisement information is presented together with the song being played back.

Along with recent popularization of music distribution services, it has become possible that a user purchases music contents from a music distribution site (music distribution server) on the Internet and directly downloads the music contents onto a client terminal for playing. In this case, feature extraction process from the song is not necessarily performed in the client terminal of the user, and a configuration scheme in which it is executed on the music distribution server is also possible. In the case of this configuration scheme, along with song purchase and downloading, the user also downloads feature information on the song and stores it in the song feature DB in the client.

Further, along with popularization of portable music playing devices, a style of listening to a favorite song while carrying about a large amount of music has become normal in recent years. Among such music playing devices, devices having communication functions such as cell phones have increased. However, in comparison with PCs, the processing capacity of the CPU installed in portable music playing devices is small, so that there is a possibility that the song feature extraction process of the present invention is not smoothly performed. When all advertisement information included in distribution object advertisement groups for individual songs to be played back are stored in a portable music playing device, this puts pressure on the data capacity of the portable music playing device, and in addition, new advertisement information cannot be displayed.

Therefore, an example of a system configuration in a portable music playing device having a communication function under the condition that it implements the present invention is shown in FIG. 10.

In the system configuration shown in FIG. 10, modules are dispersed to a PC (personal computer) 40 to be used by a user, a portable music playing device 50, and an advertisement server 60 storing an advertisement DB. The PC 40 of the user implements the song feature extraction module 1 with a high processing load, and a feature extraction result is transferred to the portable music playing device 50 along with song data. When a user selects a song to be played back on the portable music playing device 50, a feature amount of the song is transferred to the advertisement server 60 through the network, and the song categorization process and the distribution object advertisement candidate group extraction process for the song are executed. Advertisement information included in a resultantly obtained distribution object advertisement candidate group is transferred to the portable music playing device 50 via the network and displayed on the portable music playing device 50 along with the song played back by the user. By establishing this system configuration, even the portable music playing device 50 with poor processing capacity can implement the present invention.

1. A music-linked advertisement distribution method, comprising
determining degrees of association between categories of songs (hereinafter, song categories) corresponding to information showing advertisement distribution target categories and distribution object advertisements in advance;
calculating the degrees of association between an acoustic feature amount of a song being played back (hereinafter, a current song) and feature amounts of the song categories;
determining a distribution object advertisement corresponding to a song category with high degree of association as a distribution object advertisement; and
providing information on the distribution object advertisement to a user along with current song information.

2. The music-linked advertisement distribution method according to claim 1, wherein
the degree of association between the acoustic feature amount of the current song and the feature amount of the song categories is the similarity between the acoustic feature amount extracted from the current song and the feature amount of the song categories.

3. The music-linked advertisement distribution method according to claim 1, wherein
the feature amounts of the song categories can be extracted by a learning process applied to learning data consisting of sample song groups corresponding to the respective categories.

4. The music-linked advertisement distribution method according to claim 1, wherein
the current song is segmented and degrees of association between acoustic feature amounts of the segmented sections and feature amounts of the song categories are calculated,
when the song is played back, information on an advertisement corresponding to a song category with high degree of association with a section being played back is provided to the user along with song information.

5. The music-linked advertisement distribution method according to claim 1, wherein
information showing the advertisement distribution target categories are genre information on songs or information showing moods of songs, etc.

6. A music-linked advertisement distribution device, comprising:
a means for extracting features of songs stored in a song DB;
a means for playing back a song stored in the song DB;
a means for extracting features of categories of songs (hereinafter, song categories) corresponding to information showing advertisement distribution target categories;
a means for obtaining an advertisement distribution target category of a song being played back (hereinafter, current song) based on the degrees of association between an acoustic feature of the current song and features of the song categories;
a means for determining a distribution object advertisement based on the advertisement distribution target category;
a means for extracting information on the distribution object advertisement from an advertisement DB; and
a means for providing information on the distribution object advertisement to a user along with current song information.

7. The music-linked advertisement distribution device according to claim 6, wherein
the means for extracting features of the song categories extracts the features by a learning process applied to learning data consisting of sample song groups corresponding to the advertisement distribution target categories.

8. A music-linked advertisement distribution system, comprising:
a means for extracting features of songs stored in a song DB, a means for playing back a song stored in the song DB, and a means for providing information on a distribution object advertisement to a user along with information on a song being played back (hereinafter, current song), provided in a client terminal; and
a means for extracting features of categories of songs (hereinafter, song categories) corresponding to information showing advertisement distribution target categories, a means for obtaining an advertisement distribution target category of a current song based on the degrees of association between an acoustic feature of the current song and features of the song categories, a means for determining a distribution object advertisement based on the advertisement distribution target category, and a means for extracting information on the distribution object advertisement from an advertisement DB, provided in an advertisement distribution server, wherein
the client terminal and the advertisement distribution server are connected through a network.

9. The music-linked advertisement distribution system according to claim 8, wherein
a process of feature extraction from the songs is executed in a client terminal which plays back songs,
song information including a feature amount of the current song in the client terminal is sent to the advertisement distribution server via the network,
advertisement information with a high degree of association with current song information is extracted and sent to the client terminal by the advertisement distribution server, and
related advertisement information on the song being played back on a music playing application of the client terminal is provided to a user.

10. A music-linked advertisement distribution system, comprising:
a means for extracting features of songs stored in a song DB, provided in a music distribution server;
a means for downloading a song designated by a user in the song DB and a feature of the song, a means for storing the downloaded song and feature of the song, a means for playing back the downloaded song, and a means for providing information on a distribution object advertisement to the user along with information on a song being played back (hereinafter, current song), provided in a client terminal;
a means for extracting features of categories of songs (hereinafter, song categories) corresponding to information showing advertisement distribution target categories, a means for obtaining an advertisement distribution target category of the current song based on the degrees of association between an acoustic feature of the current song and features of the song categories, a means for determining a distribution object advertisement based on the advertisement distribution target category, and a means for extracting information on the distribution object advertisement from an advertisement DB, provided in an advertisement distribution server, wherein
the music distribution server, the client terminal, and the advertisement distribution server are connected through a network.

11. The music-linked advertisement distribution system according to claim 10, wherein
in the music distribution server, a process of feature extraction from songs is executed, and when a user acquires a song from the server, feature amount information on the song is also downloaded onto the client terminal, and
song information including the feature amount of the song being played back on a music playing application of the client terminal is sent to the advertisement distribution server via the network, advertisement information with a high degree of association with current song information is extracted and sent to the client terminal by the advertisement distribution server, and related advertisement information on the song being played back on the music playing application of the client terminal is provided to the user.

12. A music-linked advertisement distribution system, comprising:
a means for extracting features of songs stored in a song DB, provided in a PC;
a means for storing a song and a feature of the song transferred from the PC, a means for playing back the transferred song, and a means for providing information on distribution object advertisement to a user along with information on a song being played back (hereinafter, current song), provided in a portable music playing device;
a means for extracting features of categories of songs (hereinafter, song categories) corresponding to information showing advertisement distribution target categories, a means for obtaining an advertisement distribution target category of a current song based on the degrees of association between an acoustic feature of the current song and features of the song categories, a means for determining a distribution object advertisement based on the advertisement distribution target category, and a means for extracting information on the distribution target advertisement from an advertisement DB, provided in an advertisement distribution server, wherein
the portable music playing device and the advertisement distribution server are connected through a network.

13. The music-linked advertisement distribution system according to claim 12, wherein
a result of feature extraction process from a song is transferred from the PC to the portable music playing device along with current song information;
song information including a feature amount of a song being played back with the portable music playing device is sent to the advertisement distribution server via the network;
advertisement information with a high degree of association with current song information is extracted and sent to the portable music playing device by the advertisement distribution server; and
advertisement information with high association with the song being played back with the portable music playing device is provided to a user.
